(19) United States
(12) Patent Application Publication
(10) Pub. No.: US 2011/0233902 A1
(43) Pub. Date: Sep. 29, 2011

(54) Foldable Baby Carriage

(75) Inventor: Ichiro Ohnishi, Nara-shi (JP)

(73) Assignee: Aprica Children's Products, Inc., Osaka (JP)

(21) Appl. No.: 13/033,205

(22) Filed: Feb. 23, 2011

(30) Foreign Application Priority Data
Mar. 23, 2010 (JP) 2010-0066215

(51) Int. Cl. B62B 7/06

(52) U.S. Cl. 280/647

(57) ABSTRACT

Provided is a foldable baby carriage having a simultaneous brake mechanism enabling the baby carriage to stand upright by itself in a folded state. A simultaneous brake mechanism includes: right and left wheel restricting members capable of switching between a brake position where the right and left wheel restricting members contact the right and left wheels and a released position where the right and left wheel restricting members are separated from the right and left wheels; and a coupling mechanism placed between the right and left wheel restricting members, for simultaneously switching the positions of the right and left wheel restricting members. The coupling mechanism has a contact portion which is separated upward from a ground surface G of the right and left wheels in a deployed state of the baby carriage, and which contacts, together with the right and left wheels, the ground surface G of the right and left wheels in a folded state of the baby carriage to make the baby carriage stand upright by itself.

### BACKGROUND OF THE INVENTION

1. Field of the Invention

The present invention relates to foldable baby carriages including a simultaneous brake mechanism for simultaneously restricting rotation of right and left wheels.

2. Description of the Background Art

Simultaneous wheel brake mechanisms of foldable baby carriages have been proposed in, e.g., Japanese Patent Publication No. 2005-14894 of unexamined applications. Such a conventional simultaneous wheel brake mechanism includes an engagement member for engaging with a right rear wheel to restrict rotation of the right rear wheel, an operation member for operating this engagement member, an engagement member for engaging with a left rear wheel to restrict rotation of the left rear wheel, a driven member for operating this engagement member, and a wire for coupling the operation member and the driven member. When an operator of the baby carriage operates the operation member provided for the right rear wheel, and releases the right rear wheel from a rotation restricted state, the driven member operates together with the operation member via the wire, whereby the left rear wheel is also released from a rotation restricted state. Thus, both the right and left wheels can freely rotate.

On the other hand, if the operator of the baby carriage operates the operation member provided for the right rear wheel, and restricts rotation of the right rear wheel, the driven member operates together with the operation member via the wire, whereby rotation of the left rear wheel is also restricted. Thus, both the right and left wheels are simultaneously placed into a braked state.

Conventionally, many foldable baby carriages have been proposed in which a body of the baby carriage is reduced in size in a longitudinal direction of the baby carriage into an elongated shape when not in use, and the body in the elongated shape is deployed into its original shape when in use. If the baby carriage is folded when not in use, and the folded body of the baby carriage is horizontally placed on the floor, the baby carriage occupies a large floor area. Thus, if the body of the baby carriage can stand upright by itself instead of being horizontally placed on the floor, the baby carriage occupies a smaller area. Foldable baby carriages including a stand capable of making the baby carriage stand upright by itself have been proposed in, e.g., Japanese Utility Model Publication No. 56-54657 of unexamined applications. In the foldable baby carriage described in Japanese Utility Model Publication No. 56-54657 of unexamined applications, the stand is pivotally coupled to a lower end of a support rod extending vertically in the middle of the baby carriage in the lateral direction of the baby carriage. In an opened state where four wheels are deployed to their front right and left positions and rear right and left positions, the stand is flipped up, and does not contact the ground. Thus, the baby carriage in the deployed state is suitable for running. In a closed (folded) state where the body of the baby carriage is folded into an elongated shape so that the four wheels move toward each other, the stand is pressed down, and contacts the ground together with two of the wheels. Thus, the baby carriage in the folded state stands upright by itself.

The inventor found that there is still room for improvement in the case of applying such a stand of a conventional foldable baby carriage to a conventional baby carriage having such a simultaneous brake mechanism. That is, an operator of the baby carriage needs to flip down the stand every time he/she makes the baby carriage stand upright, and needs to flip up the stand every time he/she deploys the baby carriage, which is troublesome. Moreover, the stand is used only to make the baby carriage stand by itself, and thus is useful when the baby carriage is in the folded state, but is not useful when the baby carriage is in the deployed state.

### SUMMARY OF THE INVENTION

In view of the above problem, it is an object of the present invention to provide a foldable baby carriage having a simultaneous brake mechanism capable of making the baby carriage stand upright by itself when the baby carriage is in a folded state.

In order to achieve the above object, a foldable baby carriage according to the present invention is a foldable baby carriage capable of being folded so that right and left wheels move toward each other in a lateral direction of the baby carriage, and including a simultaneous brake mechanism for simultaneously restricting rotation of the right and left wheels. The simultaneous brake mechanism includes a left wheel restricting member capable of switching between a brake position where the left wheel restricting member contacts the left wheel and a released position where the left wheel restricting member is separated from the left wheel, a right wheel restricting member capable of switching between a brake position where the right wheel restricting member contacts the right wheel and a released position where the right wheel restricting member is separated from the right wheel, and a coupling mechanism placed between the left wheel restricting member and the right wheel restricting member, for simultaneously switching the positions of the left wheel restricting member and the right wheel restricting member. The coupling mechanism has a contact portion, which is separated upward from a ground surface of the right and left wheels in a deployed state of the baby carriage, and which contacts, together with the right and left wheels, the ground surface of the right and left wheels in a folded state of the baby carriage to make the baby carriage stand upright by itself.

The present invention can eliminate the need for an operator to flip up and down a stand every time the operator folds and deploys the baby carriage, thereby increasing operational performance. Moreover, the simultaneous brake mechanism for simultaneously restricting rotation of the right and left wheels of the baby carriage in the deployed state enables the baby carriage in the folded state to stand upright by itself. This eliminates the need to provide the stand described in Japanese Utility Model Publication No. 56-54657 of unexamined applications.

The coupling mechanism of the present invention is not specifically limited as long as the coupling mechanism is rigid enough to make the baby carriage stand upright by itself, and is deformed between the folded state and the deployed state of the baby carriage. The coupling mechanism of the present invention is, e.g., a link mechanism formed by coupling a plurality of members together. As an embodiment, the coupling mechanism has a left link coupled to the left wheel restricting member at its left end, and a right link coupled to the right wheel restricting member at its right end, and a right end of the left link is coupled to a left end of the right link so that the right and left links can pivot relative to each other. The coupling mechanism has the contact portion in the right end portion of the left link and the left end portion of the right link.

As another embodiment, the coupling mechanism has a left link coupled to the left wheel restricting member at its left end, a right link coupled to the right wheel restricting member at its right end, and a central member coupled to a right end of the left link and a left end of the right link and including the contact portion. According to this embodiment, the left link can pivot relative to the left wheel restricting member, the right link can pivot relative to the right wheel restricting member, and the central member can pivot relative to the right and left links. Thus, the central member can be separated from the ground surface in the deployed state, and can be brought into contact with the ground surface in the folded state.

The contact portion is not limited as long as the contact portion is displaced to the ground surface in the folded state. The contact portion may be displaced in any one of the forward, rearward, rightward, and leftward directions of the baby carriage, as viewed from the simultaneous brake mechanism. Preferably, the simultaneous brake mechanism is provided on rear wheels out of wheels provided at front right and left positions and rear right and left positions of the baby carriage, and the coupling mechanism is deformed so as to displace the contact portion to a position forward of the rear wheels in the folded state. The center of gravity of the baby carriage is located between the front and rear wheels and between the right and left wheels. According to this embodiment, since the contact portion of the coupling mechanism is displaced to a position forward of the rear wheels in the folded state, the contact portion can be placed at a position close to the center of gravity, enabling the baby carriage to more stably stand upright by itself.

According to the embodiment, the simultaneous brake mechanism is provided on the rear wheels. This is advantageous in that the contact portion does not hinder the operator, who stands behind the rear wheels to operate the baby carriage, from performing the folding operation. According to the present embodiment, the contact portion is separated from the ground surface by tilting backward the baby carriage in the folded state, namely in an upright self-standing state. This is advantageous in that the operator can pull the folded baby carriage in such a tilted posture, and thus can move the baby carriage in the folded state.

Thus, the simultaneous brake mechanism of the present invention has the contact portion, which is separated upward from the ground surface of the right and left wheels in the deployed state of the baby carriage, and which contacts, together with the right and left wheels, the ground surface of the right and left wheels in the folded state of the baby carriage to make the baby carriage stand upright by itself. This can not only eliminate the need for the operator to flip up and down the stand every time the operator folds and deploys the baby carriage, but also eliminate the need to provide the stand that is used only to make the baby carriage to stand by itself as in the conventional examples. The present invention not only makes it easier for the baby carriage to stand upright by itself in the folded state, and but also increases operational performance.

### BRIEF DESCRIPTION OF THE DRAWINGS

FIG. 1 is a schematic diagram showing a foldable baby carriage of the present invention in a deployed state.

FIG. 2 is a schematic diagram showing the foldable baby carriage of the present invention in a folded state.

FIG. 3 is a schematic perspective view showing a foldable baby carriage according to an embodiment of the present invention.

FIG. 4 is a side view showing a deployed state of the embodiment.

FIG. 5 is a perspective view schematically showing a simultaneous brake mechanism of the embodiment.

FIG. 6 is a side view showing a rear wheel and the simultaneous brake mechanism of FIG. 4.

FIG. 7 is a plan view showing rear wheels and the simultaneous brake mechanism of FIG. 4.

FIG. 8 is a rear view showing the simultaneous brake mechanism of FIG. 4.

FIG. 9 is a side view showing the state where the simultaneous brake mechanism of FIG. 6 is operated to restrict rotation of the rear wheel.

FIG. 10 is a side view showing a folded state of the embodiment.

FIG. 11 is a side view showing the rear wheel and the simultaneous brake mechanism of FIG. 10.

FIG. 12 is an illustration showing the rear wheels and the simultaneous brake mechanism of FIG. 10.

FIG. 13 is an illustration showing the simultaneous brake mechanism of FIG. 10.

### DESCRIPTION OF THE PREFERRED EMBODIMENTS

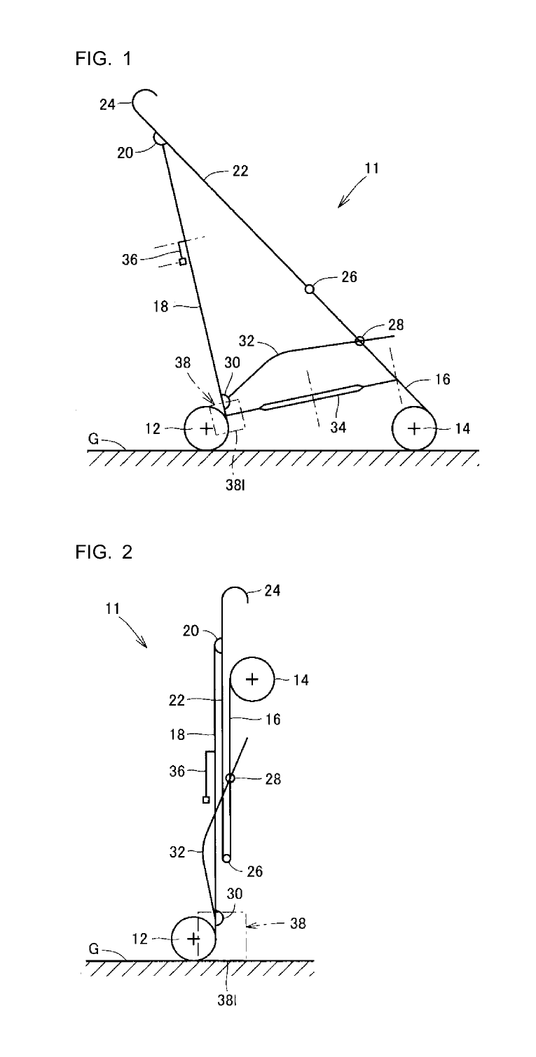

An embodiment of the present invention will be described in detail below with reference to the accompanying drawings. First, the basic structure of the present invention will be described with reference to FIGS. 1-2. FIG. 1 is a schematic diagram showing a foldable baby carriage according to an embodiment of the present invention in a deployed state. FIG. 2 is a schematic diagram showing the foldable baby carriage according to the embodiment of the present invention in a folded state. FIGS. 1-2 show the state as viewed from the right side of the foldable baby carriage. A foldable baby carriage 11 includes a simultaneous brake mechanism 38 for simultaneously restricting rotation of a right wheel 12 and a left wheel hiding behind the right wheel 12 and thus not shown in the figure. The foldable baby carriage 11 is capable of being folded into a vertically elongated shape so that the left wheel and the right wheel 12 move toward each other.

The baby carriage 11 has a front leg 16 having a front wheel 14 at its lower end, and a rear leg 18 having the right wheel 12 as a rear wheel at its lower end. The front leg 16 and the rear leg 18 are provided on the left and right side portions in a lateral direction of the baby carriage 11, respectively, and the baby carriage 11 has four wheels, namely front right and left wheels and rear right and left wheels.

An oblique member 22, which extends obliquely in longitudinal and vertical directions of the baby carriage 11, has a support shaft 20 at an intermediate position of the upper end portion of the oblique member 22. The oblique member 22 is coupled to the upper end of the rear leg 18 via the support shaft 20. The oblique member 22 has a handle portion 24 at the upper end portion of the support shaft 20. An operator, not shown, stands behind the baby carriage 11, and holds the right handle portion 24 and a left handle portion 25 to push the baby carriage 11 forward. The lower end of the oblique member 22 is coupled to the upper end of the front leg 16 via a pivot shaft 26. A support shaft 28 is provided at an intermediate position of a central portion of the front leg 16, and a support shaft 30 is provided at an intermediate position of the lower end portion of the rear leg 18. The front leg 16 and the rear leg 18 support a seat frame member 32 via the support shafts 28, 30. The seat frame member 32 extends substantially in the longitudinal direction, and a seat portion of a hammock, not shown, is placed between a front end region of the right seat frame member 32 and a front end region of a left seat frame member. A backrest portion of the hammock, not shown, is placed between the right oblique member 22 and a left oblique member. This hammock is a single continuous piece of cloth formed by the seat portion and the backrest portion, and supports the back and the bottom of an infant or small child.

As shown in FIG. 1, the front leg 16, the oblique member 22, the rear leg 18, and the seat frame member 32 form a triangular shape in the right side portion of the baby carriage 11. The same applies to the left side portion of the baby carriage 11.

An X-shaped frame 34 placed below the seat frame member 32 has an “X” shape as viewed in plan. The X-shaped frame 34 couples together the lower ends of the right front leg 16 and a left rear leg, not shown, and couples together the lower ends of a left front leg, not shown, and the right rear leg 18. The X-shaped frame 34 is formed by two bar members crossing each other, and is provided with a pivot shaft at the intersection of the two bar members, as shown by chain line in FIG. 1, and the centers of these bar members are coupled together so as to be pivotable relative to each other. The X-shaped frame 34 is also provided with pivot shafts at four positions at both ends thereof, as shown by chain line in FIG. 1, and thus is pivotally coupled to the right and left front legs and the right and left rear legs.

A V-shaped frame 36, which has a “V” shape as the baby carriage 11 is viewed from the back, is placed between the central portion of the right rear leg 18 and the central portion of the left rear leg. The V-shaped frame 36 is formed by two bar members having their respective one ends coupled together so as to be pivotable relative to each other, and is provided with a pivot shaft at the joint of the two bar members, as shown by chain line in FIG. 1. The V-shaped frame 26 is also provided with pivot shafts at both ends thereof, as shown by chain line in FIG. 1, and is pivotally coupled to the right and left rear legs.

The X-shaped frame 34 and the V-shaped frame 36 serve to maintain a constant lateral width of the baby carriage 11 in a deployed state. The X-shaped frame 34 and the V-shaped frame 36 also serve to move the right and left front legs toward each other and to move the right and left rear legs toward each other in a folded state described later. The baby carriage 11 is provided with a holding mechanism, not shown, and the holding mechanism maintains the deployed state of the baby carriage 11. Thus, the baby carriage 11 in the deployed state is not unintentionally folded, or vice versa.

The simultaneous brake mechanism 38 is provided between the lower end portion of the right rear leg 18 and the lower end portion of the left rear leg. The simultaneous brake mechanism 38 has a member for restricting rotation of the left rear wheel, a member for restricting rotation of the right rear wheel, and a coupling mechanism for coupling the right and left restricting members together, and is capable of simultaneously restricting rotation of the right and left rear wheels. When operated by the operator, the simultaneous brake mechanism 38 simultaneously acts on the right and left rear wheels to simultaneously restrict rotation of the right and left rear wheels, or to release the right and left rear wheels from the rotation restricting state to allow the right and left rear wheels to rotate freely. In the deployed state of the baby carriage 11, the right front and rear wheel 14, 12 and the left front and rear wheels contact a flat ground surface G, as shown in FIG. 1. However, the simultaneous brake mechanism 38 is separated from the ground surface G. Thus, the baby carriage 11 is capable of running smoothly in the state where rotation of the right and left rear wheels is released by the simultaneous brake mechanism 38. The baby carriage 11 is stopped while the simultaneously brake mechanism 38 is restricting rotation of the right and left rear wheels.

When the operator releases the holding mechanism, not shown, to reduce the lateral width of the baby carriage 11, the baby carriage 11 changes from the deployed state of FIG. 1 to the folded state of FIG. 2. Namely, the right and left wheels move toward each other, whereby the baby carriage 11 has an elongated shape. That is, the X-shaped frame 34 is reduced in size in the lateral direction while being extended in the longitudinal direction, and the V-shaped frame 36 is reduced in size in the lateral direction while being extended in the vertical direction, whereby the right and left rear legs move toward each other, the right and left front legs move toward each other, the right and left oblique members move toward each other, and the right and left seat frame members move toward each other.

With such deformation in the lateral direction, the front leg 16 and the oblique member 22, which continuously and linearly extend in the deployed state, are bent with the pivot shaft 26 as a fulcrum. Thus, the front leg 16 is located in front of the oblique member 22, and the front wheel 14 moves toward the handle 24 as shown in FIG. 2. Moreover, the rear leg 18 pivots about the support shaft 20 as a fulcrum, and is displaced to a position close to the oblique member 22. The seat frame member 32 pivots about the support shafts 28, 30 to extend substantially parallel to the front leg 16 and the rear leg 18. Thus, the front leg 16, the rear leg 18, the oblique member 22, and the seat frame member 32, which form a triangular shape in the deployed state, extend substantially parallel to each other in the folded state, forming a vertically elongated shape. In the baby carriage 11 having a vertically elongated shape in the folded state, the right and left wheels move toward each other in the lateral direction, and the front wheel moves forward and upward of the baby carriage 11, and moves away from the rear wheel. Note that in order to avoid complication of the drawings, the X-shaped frame 34 is not shown in FIG. 2.

Moreover, the simultaneous brake mechanism 38 is deformed. More specifically, the coupling mechanism of the simultaneous brake mechanism 38 is deformed, and a contact portion 38l of the coupling mechanism contacts the ground surface G as shown in FIG. 2. The right rear wheel 12 and the left rear wheel also contact the ground surface G. Thus, the baby carriage 11 is supported at the three points, whereby the baby carriage 11 in the folded state and thus in the vertically elongated shape stands upright by itself.

It should be understood that the coupling mechanism of the simultaneous brake mechanism 38 has a predetermined dimension in the lateral direction, and is configured so that the dimension in the vertical direction increases when the dimension in the lateral direction is reduced. The coupling mechanism is not specifically limited as long as the coupling mechanism is rigid enough to make the baby carriage stand upright by itself, and is deformed between the folded state and the deployed state of the baby carriage.

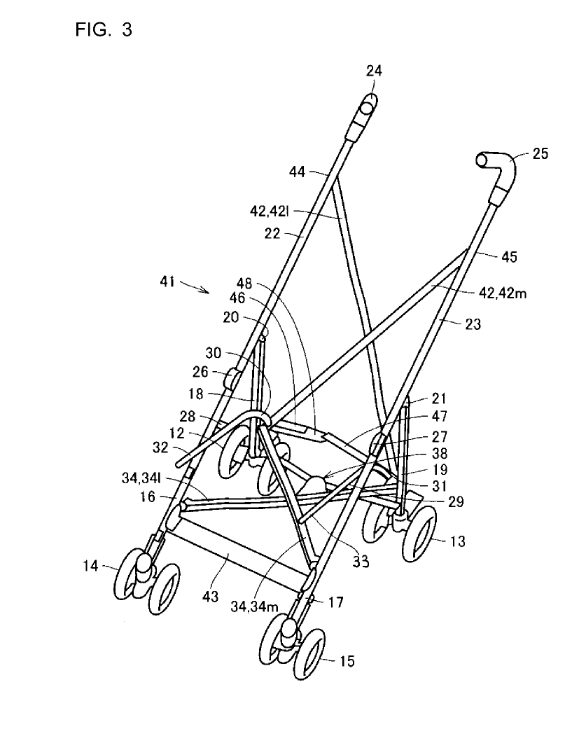

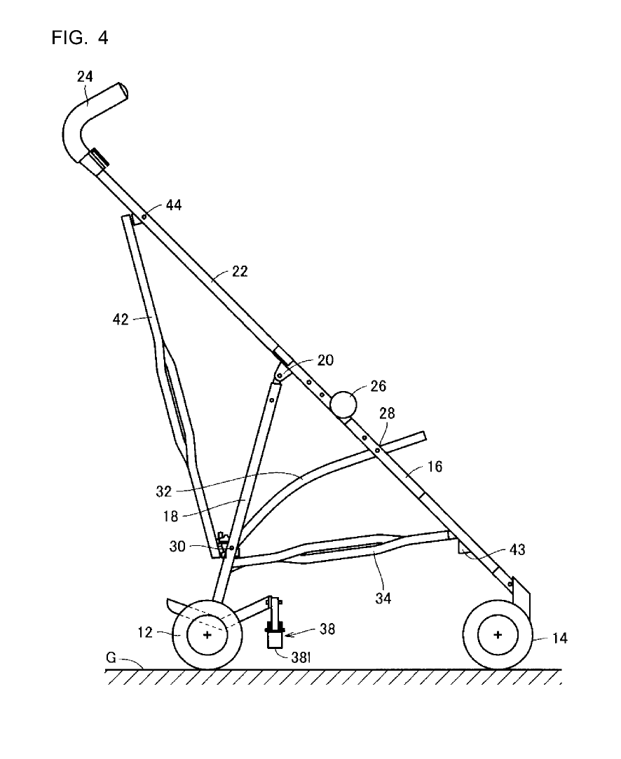

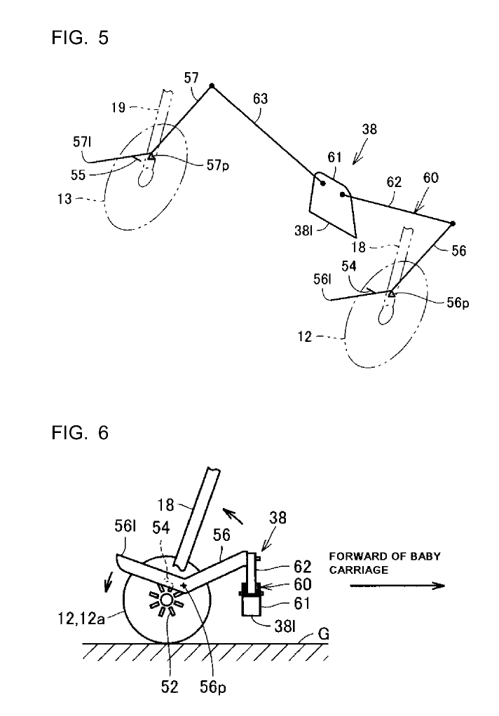

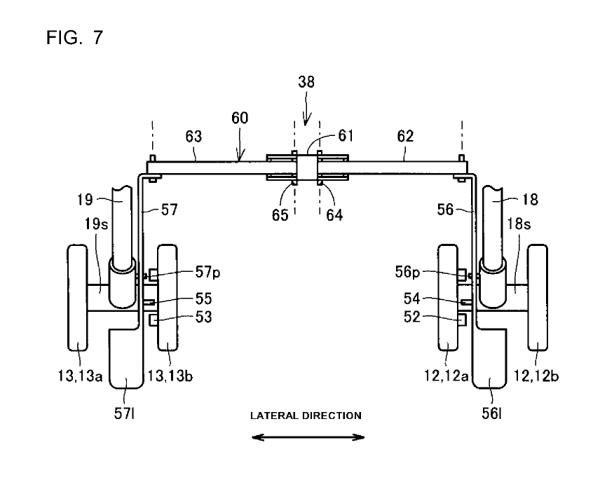

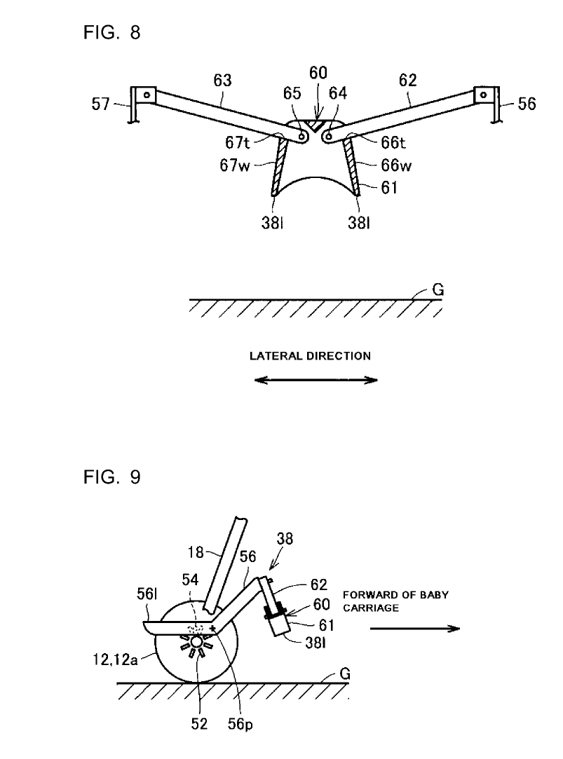

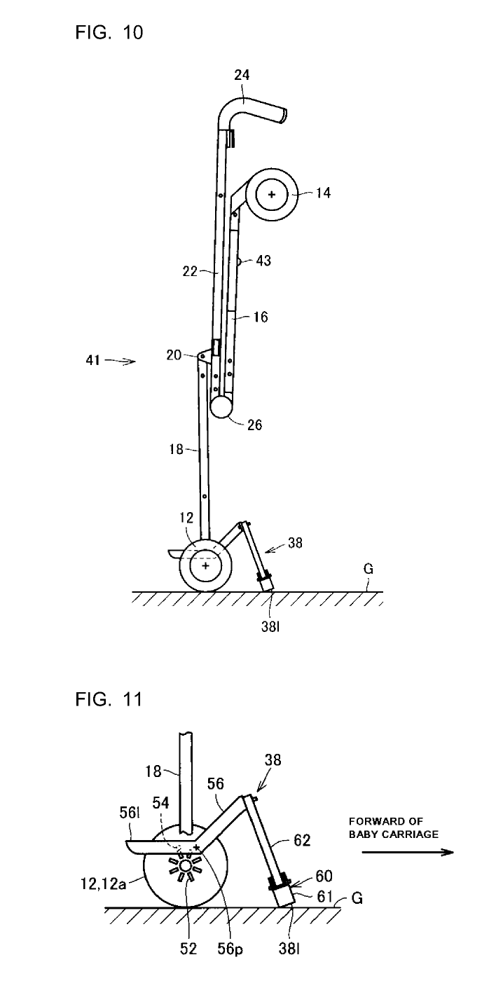

An embodiment in which the coupling mechanism is a link mechanism will be described below with reference to FIGS. 3-13. FIG. 3 is a schematic perspective view showing a foldable baby carriage according to an embodiment of the present invention. FIG. 4 is a side view showing the state of the embodiment as viewed from the right. FIG. 5 is a perspective view schematically showing a simultaneous brake mechanism of the embodiment. FIG. 6 is a side view showing a rear wheel and the simultaneous brake mechanism of FIG. 4, and in order to facilitate understanding, the lower end of the rear leg 18 to which the rear wheel 12 is attached is not shown in FIG. 6. FIGS. 4 and 6 show a simultaneous-brake released state. FIG. 7 is a plan view showing the rear wheel and the simultaneous brake mechanism of FIG. 4. FIG. 8 is a rear view showing the simultaneous brake mechanism of FIG. 4. FIG. 9 is a side view showing the state where the simultaneous brake mechanism of FIG. 6 is operated to restrict rotation of the rear wheel. FIGS. 3, 4, and 6-9 show the deployed state. FIG. 5 is common between the deployed state and the folded state. FIGS. 10-13 described later show the folded state.

In the embodiment, structures common to those of the above basic structure are denoted by the same reference characters, and description thereof is omitted. Structures different from those of the above basic structure will be described below. As shown in FIGS. 3-4, in a baby carriage 41 of the present embodiment, the overall length of the rear leg 18 is reduced, and the upper end of the rear leg 18 is connected to an intermediate position of the lower end portion of the oblique member 22. Moreover, instead of the V-shaped frame 36, an X-shaped frame 42 is placed between the right and left side portions of the baby carriage 41. Note that in the perspective view of FIG. 3, members located in the left side portion of the baby carriage 41 are denoted by reference characters 13, 15, 17, 19, 21, 23, 25, 27, 29, 31, 33. It should be understood that these members are arranged symmetrically with the above members located in the right side portion and denoted by the reference characters 12, 14, 16, 18, 20, 22, 24, 26, 28, 30, 32. The X-shaped frame 42 is formed by two bar members 42l, 42m crossing each other at their central portions, and the bar members 42l, 42m are coupled together so as to be pivotable relative to each other about the intersection thereof. The right oblique member 22 is provided with a joint 44 at an intermediate position below the handle portion 24. The right oblique member 22 is coupled to the upper end of the bar member 42l via the joint 44. The left oblique member 23 is also provided with a joint 45 at an intermediate position below the handle portion 25. The left oblique member 23 is coupled to the upper end of the bar member 42m via the joint 45. The lower end of the bar member 42l is pivotally coupled to an intermediate position of the lower end portion of the left rear leg 19. The lower end of the bar member 42m is pivotally coupled to an intermediate position of the lower end portion of the right rear leg 18.

A holding mechanism is placed between the lower end of the bar member 421 and the lower end of the bar member 42m. The holding mechanism has a right member 46 pivotally coupled to the bar member 42m, a left member 47 pivotally coupled to the bar member 42l, and a lock lever 48 fixing the positional relation between the right member 46 and the left member 47 that are coupled together so as to be pivotable relative to each other. In the deployed state of the baby carriage 41, a constant lateral dimension between the right and left side portions of the baby carriage 41 is maintained by the lock lever 48. Thus, the baby carriage 41 in the deployed state is not unintentionally folded.

Once an operator of the baby carriage 41 unlocks the lock lever 48, the lateral dimension between the right and left side portions of the baby carriage 41 can be reduced. Thus, the baby carriage 41 can be placed into the folded state. In the folded state, the X-shaped frame 42 pivots about the joints 44, 45 toward the oblique members 22, 23. At the same time, the X-shaped frame 42 pivots about its central intersection and is deformed so as to be elongated in the vertical direction and shortened in the lateral direction. Thus, the oblique members 22, 23 move toward each other, and the rear legs 18, 19 move toward each other. Thus, the baby carriage 41 is folded as shown in the side view of FIG. 10.

The right rear wheel 12 (hereinafter referred to as the “right wheel 12”) and the left rear wheel 13 (hereinafter referred to as the “left wheel 13”) will be described in detail below with reference to FIGS. 4-9. The lower end of the right rear leg 18 is coupled to the center of an axle 18s extending in the lateral direction. A right wheel 12a is rotatably attached to one end of the axle 18s located on the left side in the lateral direction. A right wheel 12b is rotatably attached to the other end of the axle 18s located on the right side in the lateral direction. Thus, the right wheel 12 is a double-wheel structure in which the right wheels 12a, 12b are coaxially positioned on the common axle 18s. Of both faces of the right wheel 12a located on the inner side in the lateral direction, the face facing the right wheel 12b has ribs 52 extending radially about the axle. In the present embodiment, eight ribs 52 are formed at regular intervals in the circumferential direction, and the ribs 52 protrude from the face of the right wheel 12a so that an engagement portion 54, described later, can be received between circumferentially adjoining ones of the ribs 52, 52. Note that the interval of the right wheel ribs 52 and the number of right wheel ribs 52 are not limited.

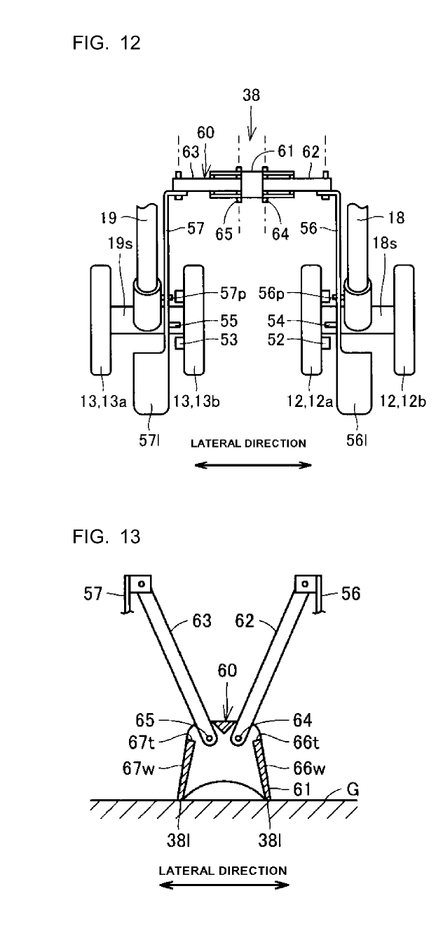

The left wheel 13 is also a double-wheel structure similar to that of the right wheel 12, and is formed by one left wheel 13a and the other left wheel 13b. Of both faces of the left wheel 13b located on the inner side in the lateral direction, the face facing the left wheel 13a has eight ribs 53 formed at regular intervals in the circumferential direction so that an engagement portion 55, described later, can be received between the ribs 53, 53. Note that the interval of the left wheel ribs 53 and the number of left wheel ribs 53 are not limited. In order to avoid complication of the drawings, some of the plurality of ribs 52, 53 are not shown in FIG. 6 (and FIG. 12).

A right wheel restricting member 56 extends between the right wheel 12a and the rear leg 18. The right wheel restricting member 56 extends substantially in the longitudinal direction of the baby carriage 41, and the front and rear ends of the right wheel restricting member 56 protrude beyond the right wheel 12. A lever 56l is formed at the rear end of the right wheel restricting member 56. The front end of the right wheel restricting member 56 is coupled to a coupling mechanism 60. In the central portion of the right wheel restricting member 56 in the longitudinal direction, the right wheel restricting member 56 is pivotally supported by the lower end of the rear leg 18 via a support shaft 56p. The engagement portion 54 is formed between the support shaft 56p and the lever 56l. The engagement portion 54 is a protrusion protruding toward the right wheel 12a. When the baby carriage 41 runs, the engagement portion 54 is not interposed between the ribs 52, 52 as shown in FIG. 6, and the wheel 12a is capable of rotating freely. Note that although detailed description is omitted, a left wheel restricting member 57 has a structure common to that of the right wheel restricting member 56, and is placed on the left wheel 13, as shown in FIGS. 5 and 7.

The coupling member 60 has a left link 63 coupled to the left wheel restricting member 57 at its left end, a right link 62 coupled to the right wheel restricting member 56 at its right end, and a central member 61 coupling the right end of the left rink 63 to the left end of the right link 62 and including a contact portion 381. The left link 63 and the right link 62 are bar-shaped rectangular members and have rigidity. The central member 61 is in the shape of an isosceles trapezoid whose lower side is longer than its upper side, and has rigidity. The right and left oblique sides of the central member 61 are located on the right and left sides of the baby carriage 41, respectively. The left link 63 is pivotally coupled to the left side of the upper side portion of the central member 61 in the lateral direction, and the right link 62 is pivotally coupled to the right side of the upper side portion of the central member 61 in the lateral direction.

The contact portion 38l is formed on the lower side of the central member 61. As shown in FIG. 6 as the baby carriage 41 is viewed from the side, the central member 61 is provided in a substantially vertically upright posture, and the thickness of the central member 61 is shown in the figure. Relatively speaking, the upper side of the central member 61 is placed at an upper position, and the lower side of the central member 61 is placed at a lower position. As shown in FIGS. 4 and 6, the contact portion 38l is separated from the ground surface G in the deployed state.

The joints at the right and left ends of the right link 62 and the joints at the right and left ends of the left link 63 have pivot axes as shown by chain lines in FIG. 7. Thus, the central member 61, the right link 62, and the left link 63 can pivot relative to each other on the same virtual plane, and the coupling mechanism 60 can be bent and extended in the lateral direction of the baby carriage 41.

As shown in FIGS. 4 and 6, in the deployed state of the baby carriage 41, the contact portion 38l is separated upward from the ground surface G of the right and left wheels 12, 13. As shown in FIG. 8, this is because the angle between the right and left links 62, 63 that form a V-shape is increased, and the coupling mechanism 60 is extended in the lateral direction, whereby the central member 61 is lifted upward by the right and left links 62, 63.

If the operator desires to stop the baby carriage 41, and steps on the right lever 561 downward as shown by arrow in FIG. 6, the right wheel restricting member 56 pivots about the support shaft 56p, and the engagement portion 54 is displaced downward into the gap between adjoining ones of the ribs 52, 52, as shown in FIG. 9. Rotation of the rear wheel 12a is restricted in this manner.

As soon as the operator steps on the right lever 56l, the front end of the right wheel restricting member 56 and the coupling mechanism 60 are lifted upward as shown by arrow in FIG. 6, and the front end of the left wheel restricting member 57 is also lifted upward. That is, the left wheel restricting member 57 also pivots about its support shaft 57p. Thus, the engagement portion 55 of the left wheel restricting member 57 is displaced downward into the gap between adjoining ones of the ribs 53, 53 of the wheel 13b. Rotation of the rear wheel 13b is restricted in this manner. Thus, the baby carriage 41 is placed into a simultaneous braked state, and is not allowed to run. According to the present embodiment, the operator can make both wheels 12, 13 incapable of rotating, by stepping on one of the right lever 56l and a left lever 57l. Note that although detailed description is omitted, it should be understood that the operator can simultaneously make not only the left wheel 13 but also the right wheel 12 incapable of rotating, even by stepping on the left lever 57l.

According to the present embodiment, since the coupling mechanism 60 is lifted without being deformed, the right and left wheel restricting members 56, 57 can be simultaneously pivoted. As shown in FIG. 8, this is because a wall 66w provided on the right side of the central member 61 is positioned below the right link 62, and a pivot joint 64 between the right link 62 and the central member 61 is positioned on the inner side in the lateral direction with respect to an upper end 66t of the wall 66w, and also because a wall 67w provided on the left side of the central member 61 is positioned below the left link 63, and a pivot joint 65 between the left link 63 and the central member 61 is positioned on the inner side in the lateral direction with respect to an upper end 67t of the wall 67w, such that the wall 67w and the pivot joint 65 are arranged bilaterally symmetrically with the wall 66w and the pivot joint 64.

Thus, when the right link 62 is lifted upward, the upper end 66t of the wall 66w contacts the right link 62, and the central member 61 is lifted upward without pivoting relatively. For a similar reason, when the central member 61 is lifted upward, the upper end 67t of the wall 67w contacts the left link 63, and the left link 63 is lifted upward without pivoting relatively. The entire coupling member 60 can be lifted in this manner.

FIG. 10 is a side view of the baby carriage 41 in the folded state as viewed from the right. In order to avoid complication of the drawings and to facilitate understanding, the seat frame member 32 and the X-shaped frames 34, 42 are not shown in FIG. 10. FIG. 11 is an enlarged side view showing the rear wheel of FIG. 10. Note that in order to facilitate understanding, the lower end of the rear leg 18 is not shown in FIG. 11. FIG. 12 is an illustration showing the rear wheel and the simultaneous brake mechanism of FIG. 10, as looked down from behind the baby carriage 41. FIG. 13 is an illustration showing the rear wheel and the simultaneous brake mechanism of FIG. 11, as viewed from behind the baby carriage 41. As shown in FIGS. 10-11, in the folded state of the baby carriage 41, the contact portion 381, together with the left wheel 13 and the right wheel 12, contacts the ground surface G of the left and right wheels, causing the baby carriage 41 to stand upright by itself.

As shown in FIGS. 12-13, in the folded state, the coupling mechanism 60 is deformed so as to be reduced in size in the lateral direction, and the central member 61 is displaced downward. More specifically, the left link 63 pivots about the joint between the left wheel restricting member 57 and the left link 63 as a fulcrum, and the right link 62 pivots about the joint between the right wheel restricting member 56 and the right link 62 as a fulcrum. This reduces the angle between the right and left links 62, 63 that form a V-shape, whereby the central member 61 is displaced downward, and the contact portion 38l contacts the ground surface G.

According to the embodiment, when the operator folds the baby carriage 41, the coupling mechanism 60 is deformed, and the central member 61 is displaced. This can eliminate the need for the operator to flip up and down the stand every time the operator folds and deploys the baby carriage as in the conventional examples, thereby increasing operational performance. Moreover, the simultaneous brake mechanism 38 for simultaneously restricting rotation of the right and left wheels of the baby carriage 41 in the deployed state enables the baby carriage 41 in the folded state to stand upright by itself. This eliminates the need to provide the conventional stand.

According to the embodiment, the simultaneous brake mechanism 38 is provided on the rear wheels 12, 13 out of the wheels 12, 13, 14, 15 provided at the front right and left positions and the rear right and left positions of the baby carriage 41. Referring to FIG. 11, in the folded state, the coupling mechanism 60 is deformed so as to displace the contact portion 38l to a position forward of the right and left wheels 12, 13 as rear wheels. Thus, the contact portion 38l can be placed at a position close to the center of gravity of the baby carriage 41. This enables the baby carriage 41 to more stably stand upright by itself. This is also advantageous in that the contact portion 38l does not hinder the operator who stands behind the rear wheels to operate the baby carriage 41.

According to the embodiment, the simultaneous brake mechanism 38 is provided on the right and left wheels 12, 13 as rear wheels. This is advantageous in that the operator, who stands behind the rear wheels to operate the baby carriage 41, can easily operate the simultaneous brake mechanism 38. According to the present embodiment, the contact portion is separated from the ground surface by tilting the baby carriage 41 in the folded state (FIG. 10), namely in an upright self-standing state, backward to a tilted posture by the operator. This is advantageous in that the operator can hold the handle portions 24, 25 and pull the folded baby carriage 41 in such a tilted posture, and thus can move the baby carriage 41 in the folded state.

Note that in the present embodiment, the right and left wheels 12, 13 are released from the simultaneous braked state as shown in FIG. 11. However, the present invention is not limited to this embodiment, and the baby carriage may be made to stand upright by itself in the simultaneous braked state.

Although the embodiment of the present invention is described above with reference to the drawings, the present invention is not limited to the illustrated embodiment. Various modifications and variations can be made to the illustrated embodiment within a scope that is the same as, or equivalent to the present invention.

The foldable baby carriage of the present invention is advantageously used in baby carriages including a simultaneous brake mechanism.

What is claimed is:

1. A foldable baby carriage capable of being folded so that right and left wheels move toward each other in a lateral direction of said baby carriage, comprising:
a simultaneous brake mechanism for simultaneously restricting rotation of said right and left wheels, wherein
said simultaneous brake mechanism includes a left wheel restricting member capable of switching between a brake position where said left wheel restricting member contacts said left wheel and a released position where said left wheel restricting member is separated from said left wheel, a right wheel restricting member capable of switching between a brake position where said right wheel restricting member contacts said right wheel and a released position where said right wheel restricting member is separated from said right wheel, and a coupling mechanism placed between said left wheel restricting member and said right wheel restricting member, for simultaneously switching said positions of said left wheel restricting member and said right wheel restricting member, and
said coupling mechanism has a contact portion, which is separated upward from a ground surface of said right and left wheels in a deployed state of said baby carriage, and which contacts, together with said right and left wheels, said ground surface of said right and left wheels in a folded state of said baby carriage to make said baby carriage stand upright by itself.

2. The foldable baby carriage according to claim 1, wherein
said coupling mechanism has a left link coupled to said left wheel restricting member at its left end, a right link coupled to said right wheel restricting member at its right end, and a central member coupled to a right end of said left link and a left end of said right link and including said contact portion.

3. The foldable baby carriage according to claim 1, wherein
said simultaneous brake mechanism is provided on rear wheels out of wheels provided at front right and left positions and rear right and left positions of said baby carriage, and
said coupling mechanism is deformed so as to displace said contact portion to a position forward of said rear wheels in said folded state.
